(19) United States
(12) Patent Application Publication
(10) Pub. No.: US 2008/0147227 A1
(43) Pub. Date: Jun. 19, 2008

(54) SYSTEMS AND METHODS FOR IMPROVED PRODUCT VARIANT CONFIGURATION AND DISTRIBUTION IN HUB-BASED DISTRIBUTION

(76) Inventor: William P. Delaney, Wichita, KS (US)

Correspondence Address: LSI CORPORATION, 1621 BARBER LANE, MS: D-106, MILPITAS, CA, 95035, US

(21) Appl. No.: 11/554,673

(22) Filed: Oct. 31, 2006

(51) Int. Cl. G06F 19/00

(52) U.S. Cl. 700/115

(57) ABSTRACT

Systems and methods for distribution of a product that may be configured in accordance with any of a plurality of sub-model configurations. An unconfigured product may be shipped to a customer accompanied by a plurality of authorization codes each representing a possible sub-model configuration of the unconfigured product. The authorization code may be encrypted and indicates the serial number of the product and the corresponding sub-model code. The product's controller may configure the product at the time of end-user installation or purchase using the authorization code and returns an acknowledgement message to the product manufacturer indicating the selected sub-model configuration of the product. The authorization codes and acknowledgement message may be encrypted using public key encryption. The acknowledgement message may be returned manually as a report or electronically to the manufacturer for product sales auditing.

### BACKGROUND OF THE INVENTION

1. Field of the Invention

The invention relates generally to distribution of products and more specifically relates to improved distribution of model variants of electronics products in a hub-based distribution environment.

2. Discussion of Related Art

It is common practice, especially in the electronics/computing industry, to manufacture a product as a single hardware solution (e.g., a single product design) configured and sold as a variety of products at multiple price points. Each configuration/price point is differentiated by the set of product features that are made available via programmable or configurable aspects of the single product design. For example, a low-cost variant of the product would offer a minimal set of features enabled the control firmware of the single product design, while a high-cost variant would offer a full-function feature set enabled in the control firmware. Such a product could be offered with a single version of control firmware embodying all supported features of all possible configurations/price points. The firmware is capable of operating at any supported functional level defined as a subset of enabled/configured features of the common firmware.

The determination of the features and functions made available by the control firmware would depend on the value of a “sub-model” code that is programmed or configured into the device at some point during its manufacturing and/or installation/configuration process. There are obvious benefits to this single, configurable product approach in that it allows a single hardware solution to be targeted at multiple market segments based on the feature/function needs of those market segments. However, inventory management of such a configurable product presents some distinct challenges where the product is distributed through a distribution chain that includes intermediate or hub distributors between the manufacturer and the end user. An intermediate distributor prefers that it not be required to stock specific quantities of each possible configuration but rather receives unconfigured products from the manufacturer that may be configured as the product is shipped to the end user or installed at the end user's site.

A simple approach of stamping products with a sub-model code during the core manufacturing process does not work well with such hub distribution models. Such a simple model implies that a specific site is used as a remote warehouse (relative to the original supplier's factory) from which products are pulled and shipped to meet the end-customer orders/demands. If a product's “personality” (i.e., sub-model/configuration) is permanently determined during manufacturing, it will be necessary to stock the hub site with a separate inventory of each sub-model. The result is a linear increase in inventory costs as the number of sub-models grows.

To allow for a single inventory at the hub site, the products that are shipped from the original supplier can have their sub-model code left in an “unstamped” state (e.g., unconfigured). These “unstamped” products are stocked in a single inventory quantity at the hub distribution site. As each unit is withdrawn from the inventory at the hub distribution site, it is stamped with its sub-model identity and then shipped to the end-customer. The method by which the sub-model code is stamped on these boards must be carefully designed.

The simplest solution to this problem is one in which the downstream customer (typically an OEM, reseller, or distributor) who controls the hub site is provided with an “uncontrolled” tool that allows the sub-model code to be arbitrarily set to any desired, supported value. A more restrictive approach could be used wherein the tool is constrained in some way to allow only an “appropriate” set of sub-model codes to be selected. The downstream customer would integrate this tool into the shipping process, such that a product would be stamped with an appropriate sub-model code only when the final customer's product selection has been made.

The fundamental negative aspect of this approach is that it is difficult for the original supplier to accurately track the sub-model identity of the products that are shipped out of the hub distribution site. From the supplier's standpoint, the products are shipped without a sub-model identity when they are delivered to the hub. The supplier would have to rely on the downstream customer (i.e., the owner/manager of the hub facility) to provide an honest report indicating how the sub-model values were assigned. The customer's honesty/integrity would be presumed in order to determine how much to charge that customer for the products that were shipped out of the hub. A dishonest distributor could simply allege that products were configured and sold with minimal features enabled (e.g., a low end sub-model of the product) while the end-users could be charged for fully featured sub-models of the product. The dishonest distributor would then keep the price difference without ever paying the manufacturer any portion of the ill-gotten, enhanced profits of the distributor.

It is evident from the above discussion that a need exists for an improved system and method for distribution of a product that may be configured in a variety of sub-models.

### SUMMARY OF THE INVENTION

The present invention solves the above and other problems, thereby advancing the state of the useful arts, by providing systems and methods for providing a distributor or customer unconfigured product that may be configured in any of a variety of sub-models using associated, encrypted authorization codes. Each authorization code associated with a product is keyed to a unique serial number for that product and to one of the plurality of possible sub-model codes in which the product may be configured. The product is stamped or configured using a selected on of the authorization codes just before shipment or installation at an end user customer site. A distributor may therefore stock only a single type of a product though a wide variety of sub-model types may be configured when a distributor ships the product. An encrypted acknowledgement message is returned to the supplier/manufacturer of the product to verify proper configuration of the product and to coordinate billing and revenue distributions.

In one aspect hereof, a method is provided for distributing a product. The method includes receiving an unconfigured product from a manufacturer wherein the product is identified by a serial number and wherein the unconfigured product is adapted to be configured as any of a variety of sub-models each identified by a corresponding sub-model indicia. The method also includes receiving a plurality of authorization codes wherein each authorization code is encrypted as a function of the serial number of the product and as a function of a particular sub-model indicia. The method further includes configuring the unconfigured product for a particular sub-model using an authorization code associated with the particular sub-model and shipping the configured product to an end user of the configured product. Lastly the method provides for reporting the shipment of the configured product to the manufacturer.

In another aspect, a method is provided for distributing a product. The method includes producing a product that is configurable into any one of a variety of sub-models wherein the product includes a private key value accessible to a controller within the product and wherein the product has a serial number accessible to the controller. The method also includes encrypting a plurality of authorization codes for the product wherein each authorization code is generated as a function of the serial number and of the private key value and a sub-model indicia wherein each authorization code corresponds to one of the variety of sub-models. The method further includes providing the product and the plurality of authorization codes to a customer. Lastly, the method includes receiving an encrypted acknowledgement message wherein the acknowledgement message indicates the product serial number and indicates the sub-model indicia of the sub-model as the product is configured by the customer and wherein the acknowledgement message is encrypted by the product using a public key value corresponding to the private key value.

Another aspect hereof provides a product distributed through a hub distribution model. The product includes an unconfigured product having a controller associated therewith wherein the controller is adapted to configure the unconfigured product to generate a configured product, wherein the configured product is in accordance with one of a plurality of sub-model configurations each associated with a corresponding sub-model indicia, and wherein the product has a unique serial number associated therewith. The product also includes a plurality of authorization codes shipped with the product wherein each authorization code is encrypted as a function of the serial number of the product and as a function of a particular sub-model indicia. The controller is adapted to configure the unconfigured product using a selected authorization code of the plurality of authorization codes to determine the sub-model indicia used for configuring the unconfigured product.

### BRIEF DESCRIPTION OF THE DRAWINGS

FIG. 1 is a block diagram of an exemplary system in accordance with features and aspects hereof to provide unconfigured products from a supplier to a distributor/customer and to configure the product in accordance with a selected sub-model configuration.

FIG. 2 is a flowchart of an exemplary method in accordance with features and aspects hereof to provide unconfigured products from a supplier to a distributor/customer and to configure the product in accordance with a selected sub-model configuration.

FIGS. 3 and 4 are flowcharts providing exemplary additional details of processing of aspects of the method of FIG. 2 in accordance with features and aspects hereof.

FIG. 5 is a flowchart of an exemplary method in accordance with features and aspects hereof to provide unconfigured products from a supplier to a distributor/customer and to receive information from the customer/distributor indicating configuration of the product.

### DETAILED DESCRIPTION OF THE DRAWINGS

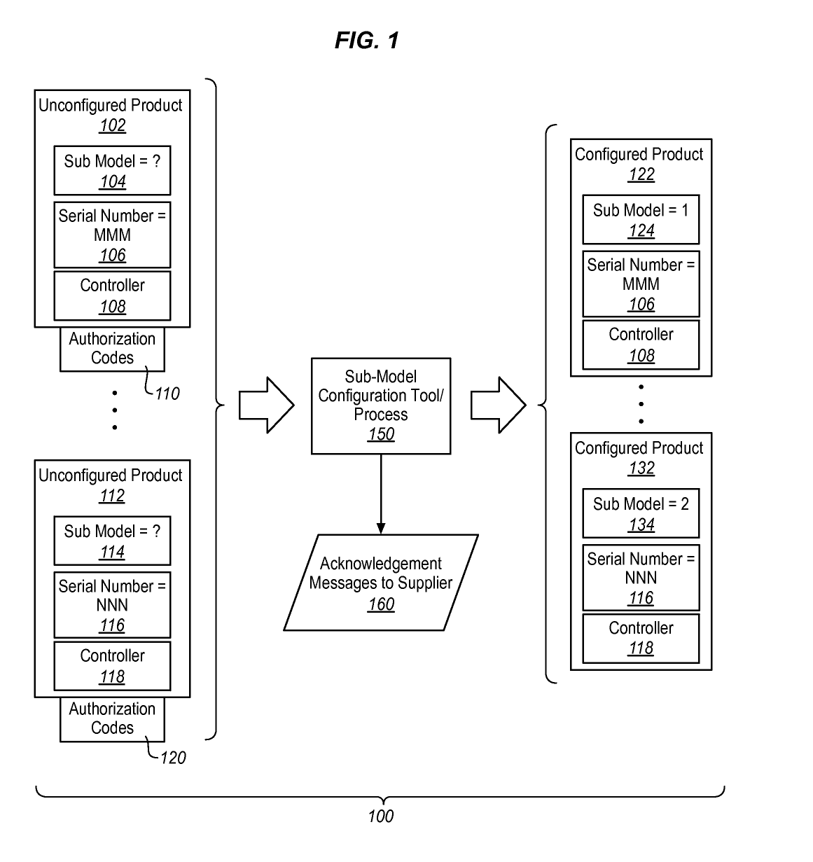

FIG. 1 is a block diagram of a system 100 for improved distribution of products configurable in accordance with any of the plurality of pre-defined sub-model configurations. System 100 may include one or more unconfigured products 102 and 112. The unconfigured product may be, for example, an electronic device or system such as a computing system or a storage system. Such products are often configurable in accordance with a number of predefined sub-model configurations in which particular features may be enabled or disabled in accordance with the particular selected sub-model configuration.

As noted above, it remains an ongoing problem to efficiently distribute such a configurable product. In particular, problems are most acute where an intermediate distributor is involved with product distribution between the manufacturer/supplier and end user customers. As presently practiced in the art, a supplier may simply provide products preconfigured in the appropriate sub-model configuration for each end user customer purchasing and utilizing the product. Thus, an intermediate distributor may be forced to maintain inventory of a wide variety of sub-models for the product. For example, an intermediate distributor may be required to maintain significant volume of a wide variety of storage systems each configured with different features enabled or disabled in accordance with the particular sub-model identification. Such an extensive volume of inventory requires substantial physical storage space as well as significant capital investment on the part of a distributor. Alternatively, the supplier may provide unconfigured products 102 and 112 to the intermediate distributor to be configured prior to shipment to a customer. The supplier must trust the intermediate distributor to properly report to the supplier regarding the exact configuration of each product shipped. The configuration shipped may vary the revenue transferred from the distributor to the supplier as well as other aspects of the supplier's business model (e.g., support and warranty services). As presently practiced the supplier has no information to reliably verify the actual configuration of a shipped product relative to the reported information from the intermediate distributor. The distributor may falsely under-report shipments so as to reflect lower cost, lower featured sub-models though the supplier could sell higher featured higher cost sub-models to its customer base (improperly keeping the additional revenues).

In accordance with features and aspects hereof, each unconfigured product 102 and 112 has an associated unique serial number 106 and 116, respectively. Further, each product may include a local controller 108 and 118, respectively, operable to control overall operation of the product. A sub-model indicator 104 and 114 associated with each product 102 and 112, respectively, may be initially manufactured to indicate that no particular sub-model configuration has yet been selected.

System 100 may further include sub-model configuration tools/process 150 adapted to configure the unconfigured products 102 and 112 to thereby generate associated configured products 122 and 132. Sub-model configuration tool/process 150 determines a desired or selected sub-model code to be assigned to each unconfigured product 102 and 112. Hence, configured products 122 and 132 include a stored sub-model indicator 124 and 134, respectively. Thus, configured product 122 represents the resulting configured product following the configuration tool/process 150 configuring unconfigured product 102. In like manner, configured product 132 represents the resulting configured product generated by sub-model configuration tool/process 150 configuring unconfigured product 112.

More specifically, each unconfigured product 102 and 112 is manufactured by the supplier and shipped with associated authorization codes 110 and 120, respectively. Each unconfigured product includes one or more associated authorization codes, each representing a particular sub-model configuration that may be selected for configuring the unconfigured product 102. As discussed further herein below, each authorization code may be an encrypted value using public key encryption techniques. The authorization code may include the serial number of the unconfigured product, and the sub-model identifier associated with the authorization code for that particular unconfigured product. Thus, the authorization codes are uniquely keyed or encrypted for the particular serial number of a particular unconfigured product.

Sub-model configuration tool/process 150 is adapted to utilize a selected authorization code to initially configure the corresponding unconfigured product in accordance with the sub-model identifier encrypted in the information of the authorization code. Once so configured to generate a corresponding configured product, sub-model configuration tool/process 150 precludes subsequent reconfiguration of the previously configured product.

Sub-model configuration tool/process 150 may represent an external device adapted for coupling to the unconfigured product 102 and 112 (e.g., through a standard communication port and/or through a specialized, dedicated diagnostic or configuration port not shown). The configuration tool/process 150 may then store the sub-model code associated with the selected authorization code in the previously unconfigured sub-model storage element 104 or 114 of an unconfigured product 102 or 112, respectively, thus generating configured product 122 and 132, respectively.

Alternatively, sub-model configuration tools/process 150 may also represent processing performed by the internal controller 108 or 118 of the associated unconfigured product 102 or 112, respectively. Internal controller 108 and 118 may interact with the user through any suitable user interface (as well known to those of ordinary skill in the art) to accept an authorization code and to configure the sub-model code 104 or 114 to generate corresponding configured products 122 or 132, respectively.

In both cases, sub-model configuration tool/process 150 (whether operable as an external device or within the controller element of an unconfigured product) uses public key encryption to generate and return to the supplier an encrypted acknowledgement message 160 confirming the successful configuration of the product. The acknowledgement message 160 may be encrypted using well known public key encryption techniques. The “plain-text” encrypted therein may include the product serial number and the selected sub-model code used to configure the previously unconfigured product. The acknowledgement message may include other useful information such as the date and time of the successful configuration. The encrypted acknowledgement message may then be forwarded to the manufacturer/supplier as a verified, authenticated indication of the precise configuration in which a product is shipped to an end user. The encrypted acknowledgment message may be transmitted to the supplier via electronic means such as direct network connection or e-mail or may be printed or otherwise generated as a “hard copy” and faxed or mailed to the manufacturer/supplier. Further, an acknowledgement message may also be generated, encrypted and transmitted to the supplier if the configuration process fails for ay reason. Such messages may indicate to the supplier attempts to improperly tamper with the configuration of a product.

System 100 therefore provides verifiable, simplified inventory control for an intermediate distributor receiving unconfigured products from a manufacturer/supplier and shipping configured products from inventory to end user customers. The intermediate distributor may maintain an inventory of identical unconfigured devices products and may configure a particular product only at the time of shipment to the end user customer. Inventory control for the intermediate distributor is therefore dramatically simplified as compared to prior techniques. Further, the encrypted acknowledgment message forwarded to the manufacturer supplier provides a reliable, verifiable audit trail of sub-model configuration of each product shipped by the distributor to corresponding end user customers.

As described above, when the product is produced by the original supplier, its sub-model code is left unconfigured (e.g., “unstamped”). A sub-model configuration (e.g., “stamping”) authorization code is produced by the original supplier for every possible sub-model code that could legitimately be assigned to the unconfigured product by the downstream customer or at the distribution hub site. A set of forms with all possible authorization codes may be attached to the box into which the controller is packaged or otherwise associated with the shipped product. The forms may preferably be attached as cards or papers attached to the product or its shipping containers. The authorization code information may be presented on the forms as printable text and/or as bar-coded information

Each authorization code includes the serial number of the associated product and the associated sub-model code for a corresponding configuration. An authorization code essentially identifies the “right” to stamp or configure a particular sub-model value onto a particular controller board. An exemplary internal structure/content of the authorization code is suggested as follows:

### AuthCode→ENC(K1priv, SubModelNumber|ControllerSerialNumber)

### SubModelNumber|ControllerSerialNumber→DEC(K1pub, AuthCode)

where the operations ENC(Kx, V) and DEC(Ky, W) are intended to represent Encryption and Decryption (respectively) via any well known public key cryptographic algorithm. Kx and Ky are the elements of a public key/private key pair. V is a plain-text input to the encryption algorithm, and W is the encrypted data input to the decryption algorithm. Public key cryptographic algorithms are characterized by the fact that data which is encrypted using the private key can only be decrypted using the public key, and data which is encrypted with the public key can only be decrypted with the private key.

A tool or process (e.g., 150 of FIG. 1) is provided to transfer the AuthCode value to a controller of the unconfigured product. As noted above, in an exemplary embodiment, the controller of the product may provide a debug/diagnosis port, such as a serial communication port, useful for field diagnosis and repair as well as for the configuration/stamping process hereof. Thus a stamping/configuring tool or system may be provided to hub distribution points that attaches to the serial port of the product's controller to permit sub-model stamping/configuration of the product. The process for stamping may then proceed as follows:
A). Attach serial cable from stamping tool system to controller's serial port.
B) Using the stamping tool, scan the bar-code from the selected authorization form.
C) The stamping tool then conveys the (encrypted) AuthCode value, as was read from the bar-code, to the product's controller.
D) Controller firmware receives the AuthCode, and decrypts it using the known value of Kpub. If the decrypted ControllerSerialNumber matches that of the controller, then the decrypted SubModelNumber will be saved/activated for the controller. This will only be done, however, if no SubModelNumber is already configured by previously performed stamping/configuration processing.
E) The controller reports back to the tool with an encrypted acknowledgement message indicating what action it took. The AckCode is constructed as follows:
AckCode→ENC(K2priv, SubModelNumber|ControllerSerialNumber)
SubModelNumber|ControllerSerialNumber→DEC(K2pub, AckCode)
The tool may save this AckCode off to a log file or other persistent storage that is used for reporting shipped product quantities/details back to the original supplier.
F) The original supplier of the products uses the public key, K2pub, to decrypt the AckCode values in the log file for an accurate reporting of how the units were configured for shipment to customers. This reporting mechanism ensures that the original supplier is able to invoice the OEM/reseller/distributor/customer the appropriate amount for the specific units that were shipped. As noted above, the acknowledgement message may be forwarded to the supplier as a printed report (with encrypted information thereon) and/or may be transmitted electronically to the supplier. Such electronic transmissions may utilize any well known networking protocols including for example, e-mail messaging, text messaging, remote procedure calls, file transfer protocol, etc.

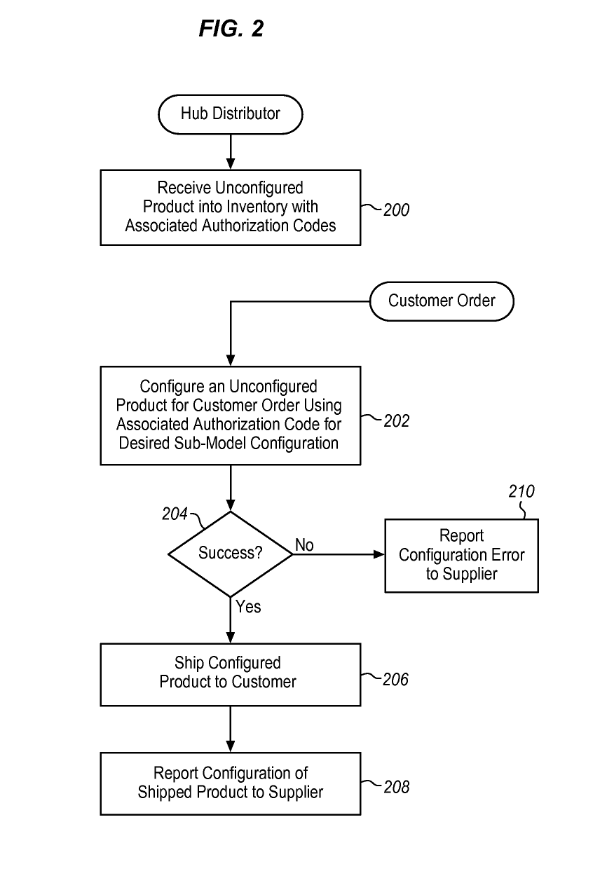

FIG. 2 is a flowchart describing a method in accordance with features and aspects hereof to improve hub distribution of a product generated by a supplier, shipped to a hub distributor, and then shipped from the distributor to individual end user customer. Element 200 represents receipt by the hub distributor of unconfigured products from the product supplier. As noted above, each unconfigured product received from the supplier may be configured to any of a variety of sub-models each representing a particular feature set the end user customer configuration along with an associated dollar value to be returned to the supplier upon shipment of a configured version of the product to an end user customer. Each unconfigured product is therefore shipped with a plurality of associated authorization codes. As noted above, the authorization codes may be provided as printed material shipped with each unconfigured product. The printed material may preferably encode the encrypted authorization code information as bar-code information or printed textual information. Providing the authorization code as machine readable printed information improves the efficiency and accuracy of utilizing the authorization code information in its encrypted form.

The hub distributor may accumulate a single inventory of such unconfigured products each with its associated plurality of authorization codes. By contrast with prior distribution techniques, the hub distributor need not maintain costly, space consuming inventory for each potential sub-model of product. Rather, the hub distributor may maintain a single inventory of unconfigured products each of which may be configured (stamped) as a particular sub-model the just prior to shipment of the product to an end user customer.

Responsive to receipt of a customer order, at element 202 the hub distributor may configure an unconfigured product in accordance with the needs of the particular customer order. The configuration processing of element 202 utilizes a selected one of the plurality of authorization codes corresponding to the sub-model features purchased by this particular end user customer. Using the encrypted authorization code, the unconfigured product may be configured or stamped with the feature set of the selected sub-model authorization code. Element 204 then determines whether the configuration processing of element 202 was successful or unsuccessful. If the configuration processing was not successful, element 210 is operable to report a configuration error to the supplier or to perform other appropriate error processing. Configuration processing of element 202 may be unsuccessful, for example, if the product has been previously configured by the distributor or some other party or if the authorization code is not for this product (as indicated by the serial number).

If the configuration processing of element 202 was successful as indicated by element 204, element 206 represents shipment of the successfully configured product to the end user customer. Element 208 then represents transmission of a report to the supplier indicating the sale and shipment of a configured version of the previously unconfigured product. As noted above, this report/message is preferably also encrypted so as to be trustworthy and verifiable by the supplier. This verification that the shipment information may then be used to coordinate payments between the distributor and product supplier based upon precise sub-model configurations of each product shipped to an end user customer.

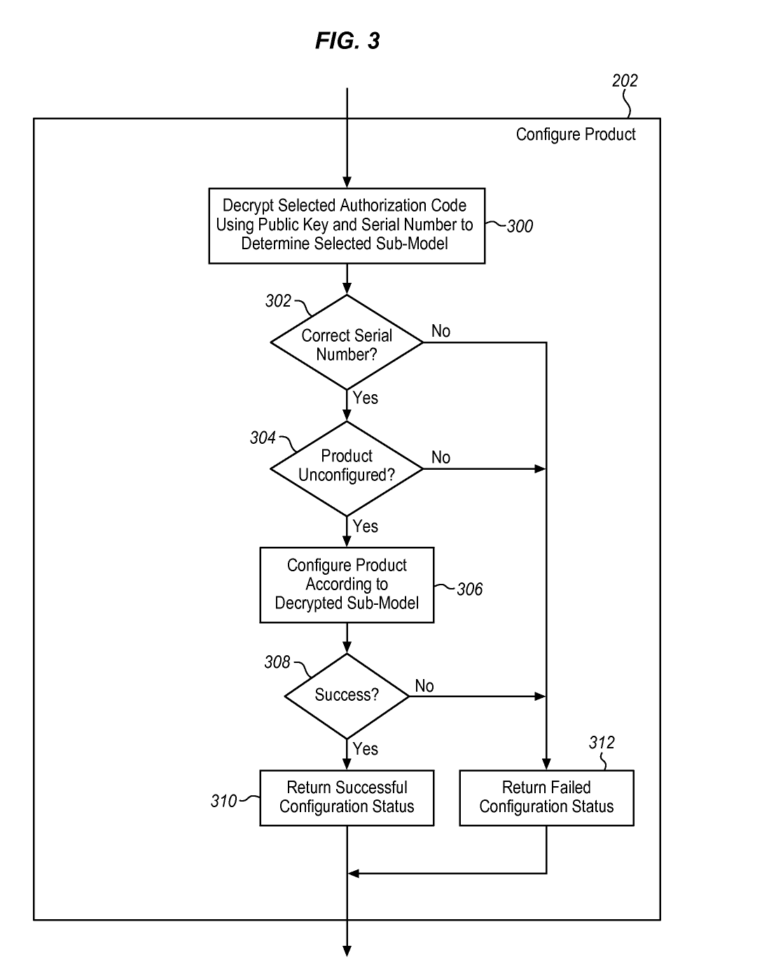

FIG. 3 is a flowchart providing exemplary additional details of the processing of element 202 of FIG. 2 to configure a product utilizing a selected one of the plurality of authorization codes associated with the product. Element 300 is first operable to decrypt the selected authorization code using public key values associated with the private-key known to the supplier and the unconfigured product. The decryption of the authorization code produces the corresponding plain-text version of the serial number and sub-model code associated with the authorization code. Element 302 then verifies that the decrypted serial number matches the serial number of the product to be configured. As noted above, the unconfigured product may include a stored serial number associated with the controller of the product. This stored serial number within the unconfigured product may be compared to the decrypted value serial number value from the authorization code. If the serial number encrypted within the authorization code does not match the serial number of the product to be configured, the element 312 is operable to return a configuration failure status for further processing as discussed above in FIG. 2. If the serial number of the decrypted authorization code matches that of the unconfigured product, element 304 is next operable to determine whether the product is still unconfigured or has been previously configured by this or similar processing. If the product has been previously configured by this or another process, processing continues with element 312 to return a configuration failure status for further processing as discussed and FIG. 2. If element 304 determines that the product is still unconfigured, processing continues with element 306 to configure the product according to the decrypted sub-model code associated with encrypted, selected authorization code.

In general, configuring the product involves storing the identified sub-model code value in an appropriate storage location associated with the controller of the product. Such a storage location may be nonvolatile persistent storage not easily erased or altered by either the distributor or by an end user customer. Once so configured, features within the product may be enabled or disabled based upon the configured sub-model code stored within the product. Element 308 then determines whether the configuration processing of element 306 was successful. If not, processing continues and element 312 to return a configuration failure status for further processing as described above that FIG. 2. If the configuration of element 306 was successful as determined by element 308, element 310 is operable to return successful configuration status information for further processing as discussed above with respect to FIG. 2.

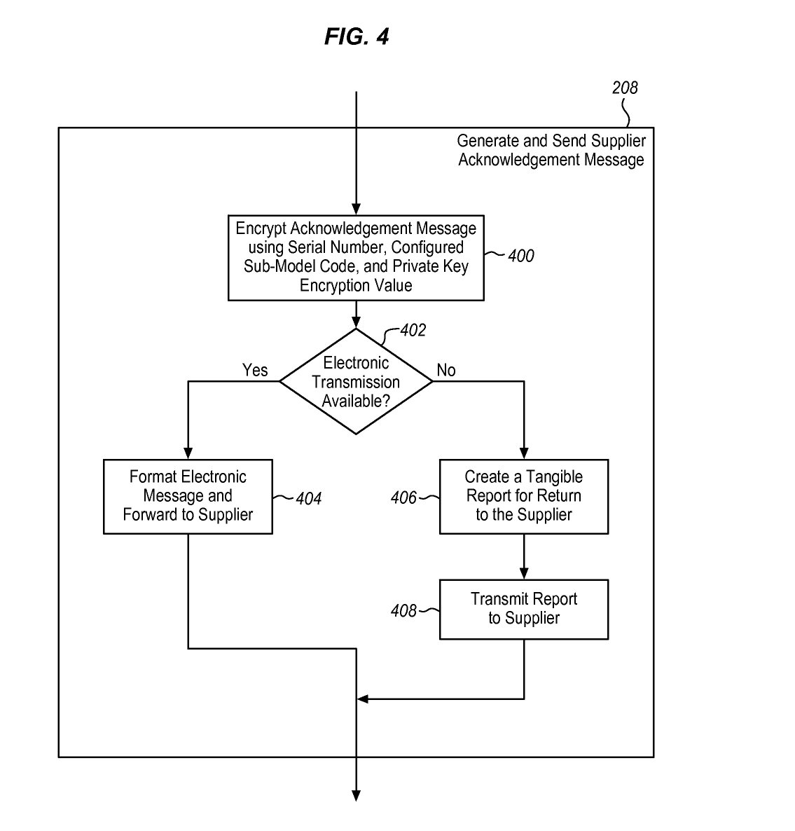

FIG. 4 is a flowchart providing exemplary additional details of the processing of element 208 of FIG. 2 to generate and transmit to a supplier an acknowledgement message verifying the configuration of a particular product in accordance with a particular sub-model. Element 400 is first operable to encrypt an acknowledgement message including, for example, the serial number of the product just configured, the configured sub-model code, and any other useful information such as date and time of the configuration process. The acknowledgement message is encrypted using a private key value known only to the manufacturer or supplier of the product (e.g., known within the controller of the product or in the configuration/stamping tool or process). Element 402 then determines whether electronic transmission of the acknowledgment message is feasible in the present environment. If so, element 404 is operable to format the acknowledgement message as an electronic message to be forwarded to the supplier and is further operable to electronically forward or transmit the acknowledgment message to the supplier.

As noted above, such electronic transmission may utilize any of several well-known, commercially available networking or other electronic communication protocols. For example, the encrypted acknowledgement message may be formatted as an e-mail message and forwarded utilizing standard e-mail networks and protocols. Alternatively, the message may be transmitted using a variety of other protocols such as text messaging, file transfer protocol, etc.

If element 402 determines that electronic transmission is not feasible in the present environment, element 406 is operable to create a tangible report with the encrypted acknowledgment information for manual return to the supplier. The printed, tangible report is then transmitted by operation of element 408 to the supplier utilizing any of several well-known techniques for transmission of a printed or tangible report. For example, the report (including one or more encrypted acknowledgement messages) may be mailed or faxed to the supplier or otherwise communicated to the supplier.

Those of ordinary skill in the art will readily recognize that the methods of FIGS. 2 through 4 may be performed by a tool or system external to the product and temporarily coupled to the product by the distributor to configure the unconfigured product prior to customer shipment. Such an external system or device may be implemented as any suitable data processing system such as a personal computer or workstation. Alternatively, the methods of FIGS. 2 through 4 may be implemented within the controller of each product. The controller may utilize a user interface capability integrated with the product and its controller to interact with a user (e.g., the distributor) to receive authorization code information and appropriately configure the product as indicated by the methods of FIGS. 2 through 4.

Further, as noted above, encrypted authorization codes and encrypted acknowledgment messages may preferably be encoded as bar-coded information to enhance ease of use and security in exchanging information between the distributor and supplier.

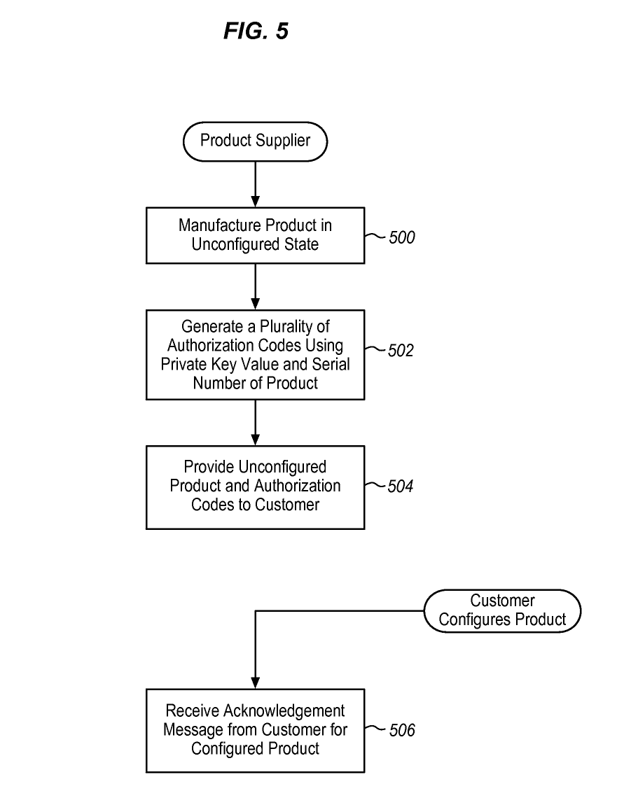

FIG. 5 is a flowchart describing another method in accordance with features and aspects hereof for product distribution as viewed from the perspective of a product supplier rather than that of the distributor or customer. Element 500 represents activities by the supplier to manufacture a product capable of being configured in any of a plurality of sub-model configurations. The product is manufactured in an initially unconfigured state to permit configuration by a distributor in response to receipt of a specific customer order.

Element 502 then generates a plurality of encrypted authorization codes to be associated with the unconfigured product. Each authorization code includes within its encrypted information the serial number of the product determined by the supplier at time of manufacture (e.g., in the processing of element 500) as well as a corresponding sub-model code. Each potential sub-model configuration useful for the particular product serial number is encrypted along with the serial number into one of the plurality of authorization codes associated with the unconfigured product.

The unconfigured product and its associated authorization codes are then provided to a customer (distributor or end-user) as indicated by element 504. At some subsequent time, the receiving customer/distributor will attempt to configure the product in accordance with a selected one of the plurality of authorization codes each representing a corresponding sub-model code. Element 506 then represents processing by the supplier/end user customer to receive an encrypted acknowledgment message from the customer/distributor indicating the particular selected sub-model code used by the customer/distributor to configure the previously unconfigured product. The encrypted data of that message as discussed above preferably includes the product serial number and the selected sub-model code. Other information such as date and time of the configuration may also be encrypted within the acknowledgement message. Further, as noted above, the encrypted acknowledgment message may be received in a printed report form (printed either as textual information or further encoded as bar-coded information). Still further, the acknowledgement message may be received by the supplier by receipt of the printed output via facsimile or mail transmission or the acknowledgment message may be electronically received. As noted above, such electronic message transmissions may include e-mail, text messaging, file transfer protocol, and any of a variety of other well-known, commercially available electronically communication media and protocols.

Those of ordinary skill in the art will readily recognize a wide variety of equivalent method steps to provide similar functionality to that described above with respect to FIGS. 2 through 5.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

What is claimed is:

1. A method of distributing a product, the method comprising:
receiving an unconfigured product from a manufacturer wherein the product is identified by a serial number and wherein the unconfigured product is adapted to be configured as any of a variety of sub-models each identified by a corresponding sub-model indicia;
receiving a plurality of authorization codes wherein each authorization code is encrypted as a function of the serial number of the product and as a function of a particular sub-model indicia;
configuring the unconfigured product for a particular sub-model using an authorization code associated with the particular sub-model;
shipping the configured product to an end user of the configured product; and
reporting the shipment of the configured product to the manufacturer.

2. The method of claim 1 further comprising:
verifying, prior to configuring, that the unconfigured product has not been previously configured,
wherein the steps of configuring and shipping are conditionally performed only if the product is verified as not previously configured.

3. The method of claim 1
wherein the authorization code used to configure the product is encrypted by the manufacturer using a private key value,
wherein the step of configuring further comprises:
decrypting the encrypted authorization code used for configuring the product using a public key value corresponding to the private key value.

4. The method of claim 3 wherein the private key is known only to the manufacturer.

5. The method of claim 1
wherein the step of reporting further comprises:
generating an encrypted acknowledgement message wherein the acknowledgement message indicates the product serial number and indicates the sub-model indicia of the configured product and wherein the acknowledgement message is encrypted by the product using a private key value,
wherein the step of reporting further comprises:
sending the encrypted acknowledgement message to the manufacturer wherein the encrypted acknowledgement message may be decrypted using a public key value corresponding to the private key.

6. The method of claim 5 wherein the private key is known only to the manufacturer.

7. The method of claim 5
wherein the step of sending further comprises:
generating a report providing the acknowledgement message; and
physically sending the report to the manufacturer.

8. The method of claim 5
wherein the step of sending further comprises:
electronically sending the acknowledgement message to the manufacturer.

9. A method for distributing a product, the method comprising:
producing a product that is configurable into any one of a variety of sub-models wherein the product includes a private key value accessible to a controller within the product and wherein the product has a serial number accessible to the controller;
encrypting a plurality of authorization codes for the product wherein each authorization code is generated as a function of the serial number and of the private key value and a sub-model indicia wherein each authorization code corresponds to one of the variety of sub-models;
providing the product and the plurality of authorization codes to a customer; and
receiving an encrypted acknowledgement message wherein the acknowledgement message indicates the product serial number and indicates the sub-model indicia of the sub-model as the product is configured by the customer and wherein the acknowledgement message is encrypted by the product using a public key value corresponding to the private key value.

10. The method of claim 9
wherein the step of receiving further comprises:
physically receiving a report generated by the customer which report provides the acknowledgement message.

11. The method of claim 9
wherein the step of receiving further comprises:
electronically receiving the acknowledgement message from the customer.

12. A product distributed through a hub distribution model, the product comprising:
an unconfigured product having a controller associated therewith wherein the controller is adapted to configure the unconfigured product to generate a configured product, wherein the configured product is in accordance with one of a plurality of sub-model configurations each associated with a corresponding sub-model indicia, and wherein the product has a unique serial number associated therewith; and
a plurality of authorization codes shipped with the product wherein each authorization code is encrypted as a function of the serial number of the product and as a function of a particular sub-model indicia,
wherein the controller is adapted to configure the unconfigured product using a selected authorization code of the plurality of authorization codes to determine the sub-model indicia used for configuring the unconfigured product.

13. The product of claim 12
wherein the authorization code is encrypted using a private key value, and
wherein the controller is adapted to decrypt the authorization code using a corresponding public key value to determine the sub-model indicia used to configure the unconfigured product.

14. The product of claim 13
wherein the controller is adapted to generate an encrypted acknowledgement message, wherein the acknowledgement message indicates the serial number of the product and indicates the sub-model indicia used to configure the product, and wherein the acknowledgement message is encrypted by the product using a public key value corresponding to the private key value.
